(19) United States
(12) Patent Application Publication
(10) Pub. No.: US 2016/0071131 A1
(43) Pub. Date: Mar. 10, 2016

(54) SYSTEM AND METHOD FOR MAPPING PRODUCT CHOICE FACTORS

(71) Applicant: VENNLI, INC., South Bend, IN (US)

(72) Inventors: Pooya Ryan Ghiaseddin, Granger, IN (US); Michael Joseph Beck, Mishawaka, IN (US)

(73) Assignee: VENNLI, INC., South Bend, IN (US)

(21) Appl. No.: 14/850,028

(22) Filed: Sep. 10, 2015

Related U.S. Application Data
(60) Provisional application No. 62/048,620, filed on Sep. 10, 2014.

(51) Int. Cl. G06Q 30/02; G06T 11/20

(52) U.S. Cl. CPC G06Q 30/0203; G06T 11/206

(57) ABSTRACT

A method is provided for mapping a pin location related to a choice factor weighed by a plurality of customers when deciding what brands, products or services to purchase. The pin is mapped on a three circle Venn diagram including a plurality overlapping and non-overlapping zones. The illustrated method includes analyzing survey data obtained from the plurality of customers related the choice factor; determining in which zone of the three circle Venn diagram to place the pin associated with the choice factor; and positioning each pin in the determined zone to provide a visual indication of a level of importance of the choice factor associated with the pin.

### PRIORITY

The present application claims priority to and incorporates by reference the disclosure of U.S. Provisional Patent Application No. 62/048,620 filed Sep. 10, 2014 titled “SYSTEM AND METHOD FOR MAPPING PRODUCT CHOICE FACTORS.”

### FIELD

The present disclosure relates generally to the production of visual representations of data. The present disclosure relates more specifically to the production of visual representations of competitive product feature analysis to more readily show the status of one or more products relative to customer desires.

### BACKGROUND AND SUMMARY

Even more specifically, the present disclosure relates to a system and method for visually mapping product “choice factors” which are attributes weighed by customers when deciding what products or services to purchase. The present disclosure further relates to a system and method for mapping a customer's choice factors on a Venn diagram to provide a visual indication of what customers want, who the customers perceive to be delivering wanted choice factors, and where the customers' needs are unmet. The specific points where the choice factors are mapped is meaningful. The mapped points or “pins” provide a visual indication that allows companies to evaluate ideas to address the choice factors based on cost, timing and projected return on investment. This results in a prioritized and actionable strategy driven by the customers' opinions.

An illustrative embodiment of the method represents attributes as a position on a three circle Venn diagram. The attributes that fall within the three circles of the Venn diagram represent respectively; attributes offered by a particular company's brand, product or service (upper left circle), attributes offered by a competing brand, product or service (bottom middle circle), and finally attributes desired by a customer (upper right circle). Where 2 or 3 circles overlap represents equivalence between what the two brands offer or equivalence between what is offered by a brand, product or service and what is desired by a customer. On the Venn diagram, exact attribute placement meaningfully reveals the degree importance and the degree of perceived ownership of a particular attribute by a brand, product or service from the perspective of the customer.

The mapping system and method of the present disclosure uses survey answers obtained from customers to provide data points related to the choice factors. The present system and method converts survey scores on a scale of 0 to 1 for three different measures, namely (1) the importance of an attribute to a customer during a purchase decision, (2) the performance of a brand, product or service with regard to that attribute from the perspective of the customer, and (3) performance of the competing brand, product or service with regard to that attribute from the perspective of a customer to bivariate coordinates for systematically and predictably plotting the choice factor pins to the three circle Venn diagram as discussed below.

In an illustrated embodiment of the present disclosure, a computer implemented method is provided for mapping a pin location related to a choice factor weighed by a plurality of customers when deciding what brands, products or services to purchase. The pin is mapped on a three circle Venn diagram including a plurality overlapping and non-overlapping zones. The illustrated method includes analyzing with the computer survey data obtained from the plurality of customers related the choice factor; determining with the computer in which zone of the three circle Venn diagram to place the pin associated with the choice factor; and positioning each pin in the determined zone with the computer to provide a visual indication of a level of importance of the choice factor associated with the pin.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a Venn diagram of the present disclosure including a plurality of zones to visualizing the importance of attributes weighed by customers when deciding on what products and/or services to purchase;

FIG. 2 illustrates a method for determining whether an attribute falls within a customer circle of the Venn diagram;

FIG. 3 illustrates a method for determining whether an attribute is an unmet need;

FIG. 4 illustrates a method for determining a degree of ownership of a met need;

FIG. 5 illustrates a method for determining a degree of ownership of an undesired attribute;

FIGS. 6-12 illustrate methods for determining attribute positions within various zones of the Venn diagram of the present disclosure;

FIG. 13 illustrates a bivariate coordinate system with a three circle Venn diagram in accordance with an illustrated embodiment of the present disclosure;

FIG. 14 is a block diagram illustrating a choice factor mapping system in accordance with one embodiment of the present disclosure;

FIG. 15 is a chart illustrating actual choice factors importance and performance ratings and the resulting coordinates obtained from data of a customer survey;

FIG. 16 illustrates choice factor positions on the three circle Venn diagram obtained by plotting the actual choice factors of FIG. 15;

FIG. 17 is a screen shot displayed on a computer screen illustrating the mapped choice factors on the three circle Venn diagram;

FIG. 18 is a flowchart showing steps involved in preparing the diagram of any of FIGS. 1-13, and 16-17; and

FIG. 19 is a flowchart showing steps involved in locating a pin within a particular zone of the Venn diagram of any of the preceding Figs.

### DETAILED DESCRIPTION OF THE DRAWINGS

For the purposes of promoting an understanding of the principles of the present disclosure, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of the principles of the invention which would normally occur to one skilled in the art to which the invention relates.

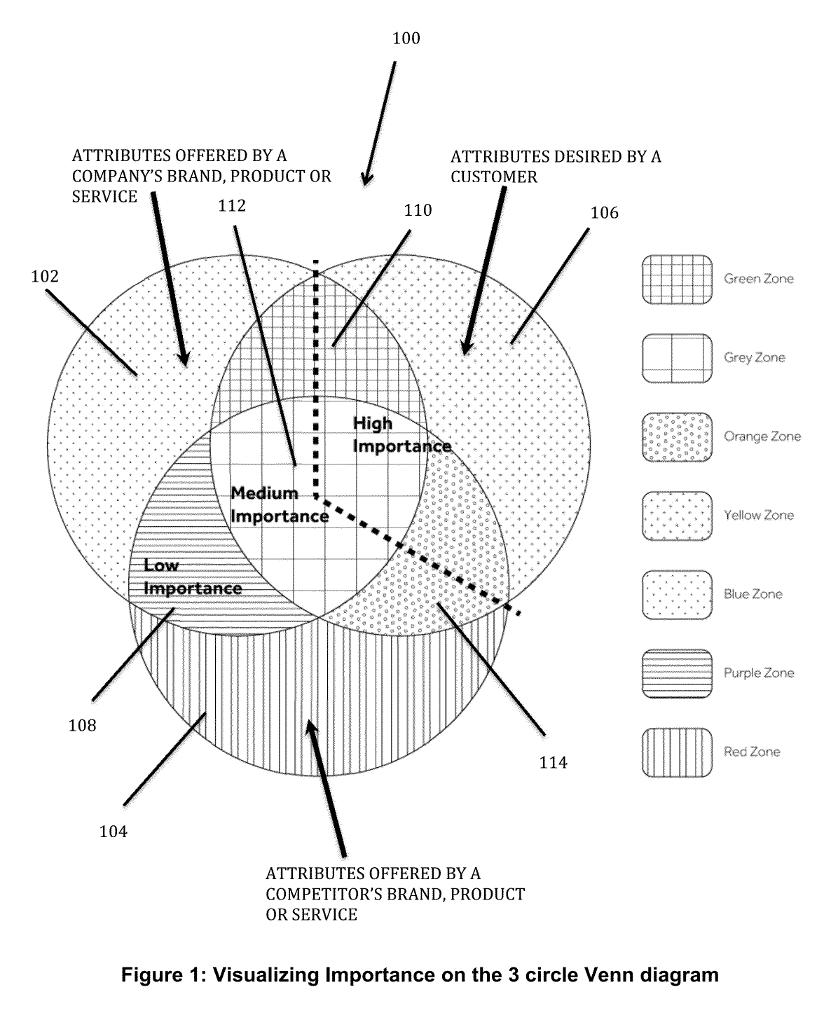

The mapping system and method of the present disclosure is based on data points generated using the Vennli survey format. In the illustrated embodiment, the surveys for obtaining the choice factor data may use the survey platform available from Vennli, Inc. located in South Bend, Indiana (see vennli.com). In an illustrated embodiment, survey questions are automatically generated based on selected choice factors. Surveys are illustratively sent to contact lists of a company. The surveys are used to determine the importance of “choice factors” which are attributes weighted by customers when deciding what brands, products or services to purchase. Illustrative choice factor categories include benefits, costs, experience, features, quality, or other factors. Customers are asked to complete a survey related to their next product choice. The survey determines which attributes are important to the customer when choosing between different products. Illustratively, each choice factor may be addressed using a “strongly disagree”, “disagree”, “neither agree nor disagree”, “agree”, and “strongly agree” response option. Answers from the survey for each choice factor are processed and converted to a zero to one scale. The survey data is processed and mapped to a Venn diagram outlined below. The mapping system and method can be understood as firstly plotting Importance before offsetting to represent the degree of ownership by a brand, product or service. See FIG. 1.

The mapping system and method is summarized with the following steps:
(1) Obtain responses for each Choice Factor.
(2) Convert responses from a scale of 1 to 5 to a scale of 0 to 1.
(3) Calculate scores for Importance [Iₙ], Company Performance [Rₙ₁] and Competitor Performance [Rₙ₂] for each Attribute (Choice Factor),
(4) Determine a proper zone within the venn diagram 100 based on whether the scores are equal to, greater than or less than the Importance Threshold [Iₜ], Rating Threshold [Rₜ] and Rating Difference Threshold [R_{d}] respectively.
(5) Determine where in each zone the Attribute (Choice Factor) pin is to be placed.
(6) Providing a visual indicator at the proper placement for the pin.

### Definitions

Top-box method: the method by which responses generated on a 5-point scale are illustratively recalculated on a scale of 0 to 1.

Importance [Iₙ]: The degree of importance a customer attaches to a specific Choice Factor when choosing between one offering and another.

Importance Threshold [Iₜ]: The point on a scale (illustratively 0 to 1) that delineates between what is important to a customer and what is not. Embodiments include setting this value at 0.6 or 2 but this value may be different.

Rating [Rₙ₁ & Rₙ₂]: The strength of association an offering has to a specific Choice Factor from the perspective of the customer. Sometimes referred to as Performance.

Rating Threshold [Iₜ]: The point on a scale (illustratively 0 to 1) that delineates between when a company's performance is satisfactory to a customer and when it is not. Embodiments include setting this value at 0.6 or 2 but this value may be different.

Rating Difference Threshold [R_{d}]: The point on a scale (illustratively 0 to 1) that corresponds to when a company's performance, relative to a competitor's performance with regards to a specific Choice Factor, is so much greater that the difference in performance represents a distinct competitive advantage. Embodiments include setting this value at 0.2 but this value may be different as appropriate.

Performance: Used interchangeably with Rating.

### Zone Placement Examples

FIG. 1 illustrates an exemplary three circle Venn diagram 100 in accordance with an illustrated embodiment of the present disclosure. The upper left circle 102 represents attributes offered by a particular company's brand, product or service. The lower middle circle 104 represents attributes offered by a competitor's brand, product or service. Attributes desired by customer are illustrated by the upper right circle 106. FIG. 1 illustrates a visualization of importance of the particular choice factors in the zones of the Venn diagram 100.

In an illustrated embodiment, choice factor pins are mapped to the three circle Venn diagram as follows:

Step 1: Obtain responses for each Choice Factor.

Step 2: Convert responses from a scale of 1 to 5 to a scale of 0 to 1.

Step 3: Calculate scores for Importance [In], Company Performance [Rn1] and Competitor Performance [Rn2] for each Attribute (Choice Factor),

Step 4: Determine a proper zone within the Venn diagram.

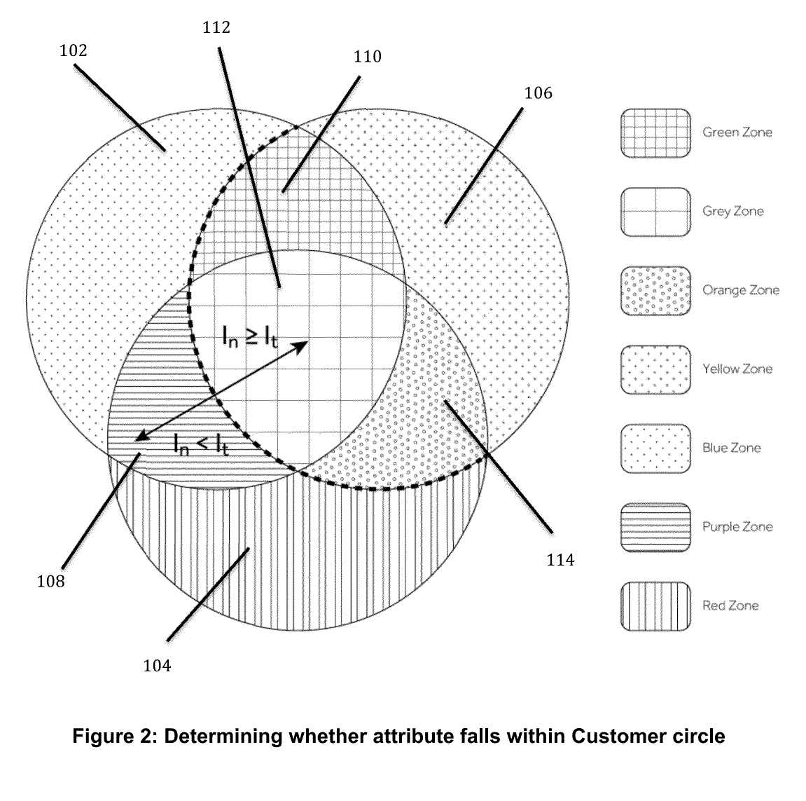

Step 4a: (FIG. 2) Determining whether the Choice Factor pin lies inside or outside the Yellow Customer Circle 106. See FIG. 2.

If the Importance of Choice Factor n [Iₙ] is equal to or greater than the Importance Threshold [Iₜ], in other words Iₙ≧Iₜ, then Choice Factor n falls inside the yellow Customer circle 106. Otherwise the Choice Factor n falls outside the yellow Customer circle 106 in exclusively either the blue Company circle 102 or the red Competitor circle 104, or in the overlap purple zone 108 shared by circles 102, 104.

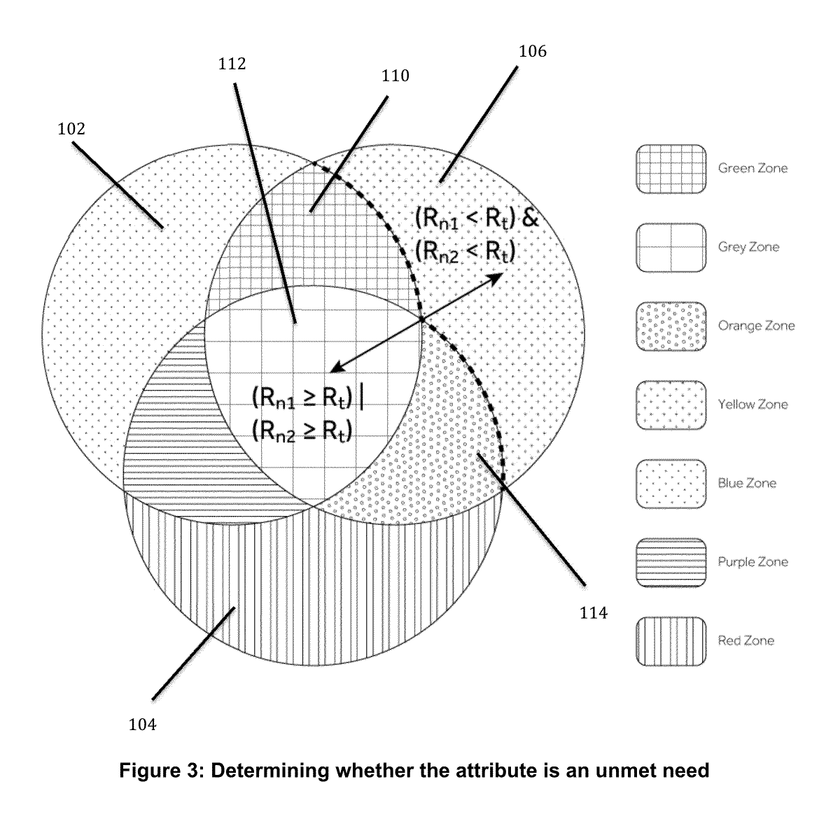

Step 4b: (FIG. 3) Determining whether the Choice Factor pin lies inside or outside both the Company Performance Circle 102 and the Competitor Performance Circle 104 given that the pin is already within the Yellow Customer Circle 106.

There are two rating measures for each Choice Factor, Rₙ₁ and Rₙ₂ corresponding to the strength of association the Choice Factor has to the Company and the Competitor respectively. We refer to this strength of association rating as Performance or Rating. Specifically, the Company rating is symbolized as [Rₙ₁] while the Competitor rating is symbolized as [Rₙ₂].

If at least one rating measure is equal to or greater than the Rating Threshold [Rₜ], in other words Rₙ₁≧Rₜ or Rₙ₂≧Rₜ, then the Choice Factor will fall into either the Green 110, Grey 112 or Orange Zone 114. Otherwise the Choice Factor will fall into the Yellow Zone 130.

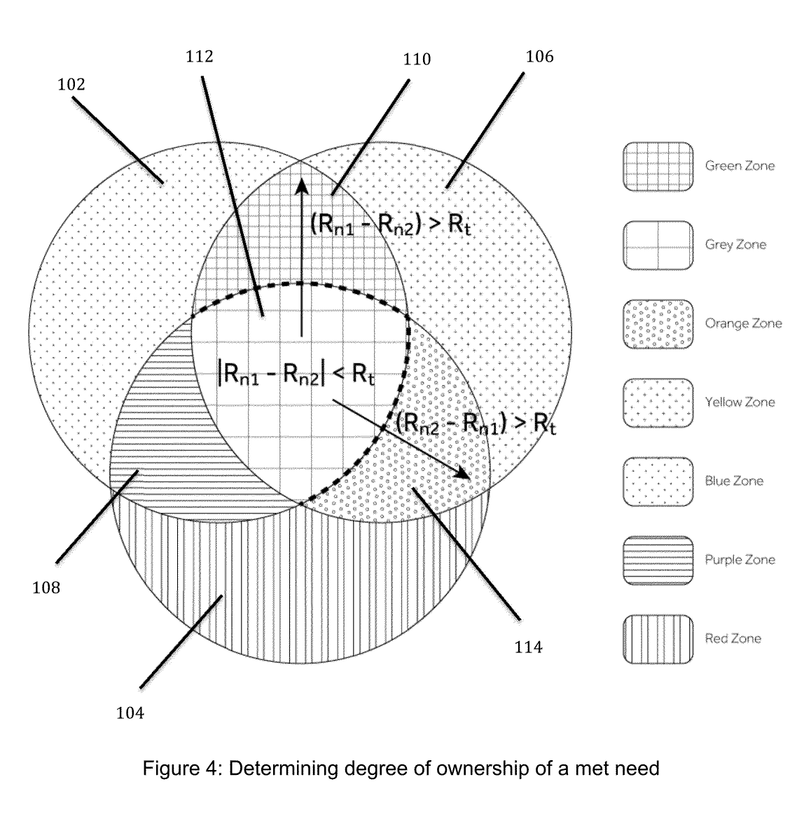

Step 4c: (FIG. 4) Determining whether the Choice Factor pin lies in the Grey Zone 112, the Green Zone 110 or the Orange Zone 114 given that it lies within the Yellow Customer Circle 106. See FIG. 4.

Given that at least one of the performance ratings is greater than the Rating Threshold [Rₜ], in other words Rₙ₁≧Rₜ or Rₙ₂≧Rₜ, then if the magnitude of the difference in ratings between the Company and the Competitor is less than the Rating Difference Threshold [R_{d}], in other words |Rₙ₁−Rₙ₂<R_{d}, then the Choice Factor falls within the Grey zone 112. If the difference is greater than the Rating Difference Threshold [R_{d}], then it falls in the Green Zone 110 if Rₙ₁>Rₙ₂, or the Orange Zone 114 if Rₙ₁<Rₙ₂.

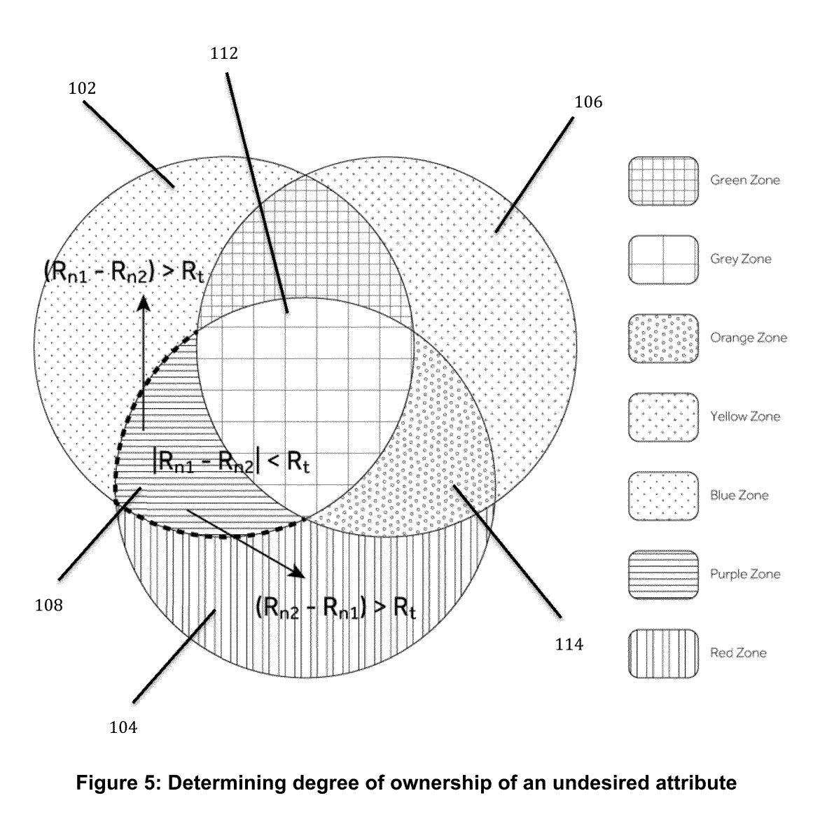

Step 4d: (FIG. 5) Determining whether the Choice Factor pin lies in the Purple Zone 108, the Blue Zone 132 or the Red Zone 134 given that Importance is less than the Importance Threshold. See FIG. 5.

Given that the Importance of a Choice Factor n [Iₙ] is less than the Importance Threshold [Iₜ], in other words Iₙ<Iₜ, then if the magnitude of the difference in ratings is less than the Rating Difference Threshold [R_{d}], then Choice Factor n falls within the Purple Zone 108. If the difference is greater than the Rating Difference Threshold, then it falls in the Blue Zone 132 if the Company Performance rating [Rₙ₁] is greater than the Competitor Performance rating [Rₙ₂], in other words if Rₙ₁>Rₙ₂. If the difference is greater than the Rating Difference Threshold, then it falls in the Red Zone 134 if the Competitor Performance rating [Rₙ₂] is greater than the Company Performance rating [Rₙₜ], in other words if Rₙ₁<Rₙ₂.

Step 5: Having determined in which zone the Choice Factor pin is to be located, the specific location of the pin is then determined.

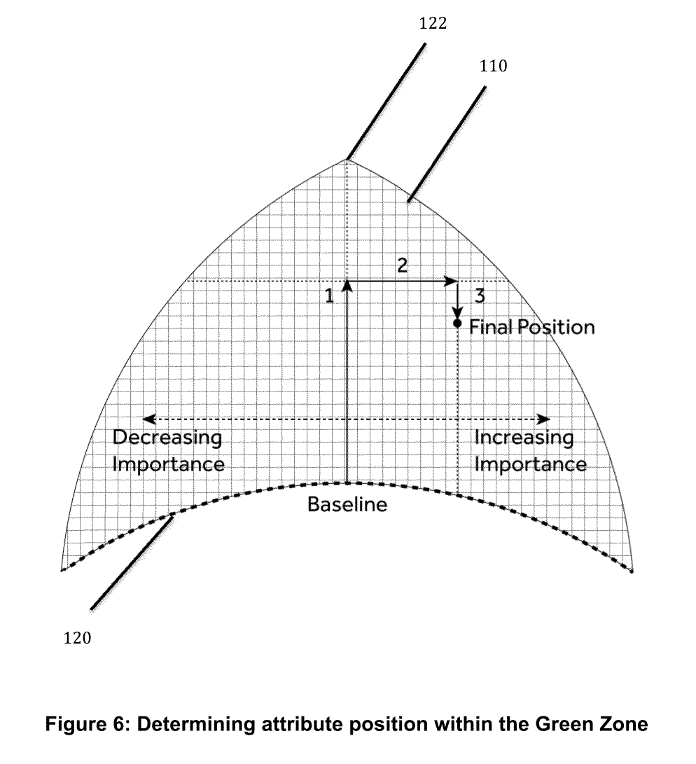

Green Zone (FIG. 6) The Green Zone 110 displays Choice Factors that lie within both the Company circle 102 and the Customer circle 106. See FIG. 6.

(1) See vector 1. At the Baseline the minimum Rating Difference is 0.2, while the maximum Rating Difference is 1.0. A logarithmic scale determines the distance travelled along vector 1: a maximum score of 1.0 would place the pin at the pinnacle (apex) 122 of the Green Zone 110, while a score equal to or greater than the Rating Difference Threshold [R_{d}] would place the pin temporarily at the Baseline 120. In an illustrative embodiment the Rating Difference is calculated using a simple subtraction involving the Company Rating [Rₙ₁] and the Competitor Rating [Rₙ₂]:Rₙ₁−Rₙ₂. The scores prior to this subtraction have already been converted to a 0.0 to 1.0 scale, thus the maximum difference is 1.0 and the minimum difference is −1.0. Within each zone however, we are concerned with the magnitude of the difference so the effective minimum and maximum differences are 0.0 and 1.0 respectively.

(2) See vector 2. Once the preliminary height is determined, the horizontal movement is determined based on the Importance of the Choice Factor. As the importance score approaches the minimum threshold the pin drifts left towards the left edge of the Green Zone 110. As Importance approaches a perfect score of 1.0, the pin drifts towards the right edge of the Green Zone 110.

(3) See vector 3. Once the horizontal position is determined, the height is recalibrated to reflect the curvature along the top and bottom of the zone relative to the new horizontal position for an exact placement. A visual indicator is then provided at the exact indicated placement (step 6).

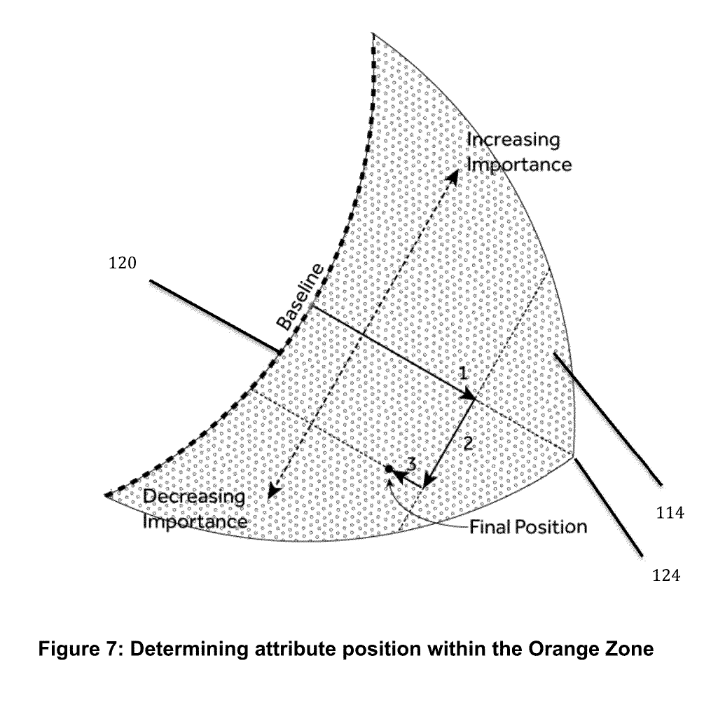

Orange Zone (FIG. 7) The Orange Zone 114 displays Choice Factors that lie within both the Competitor circle 104 and the Customer circle 106. See FIG. 7.

(1) See vector 1. At the Baseline 120 the minimum Rating Difference is 0.2, while the maximum Rating Difference is 1.0, this is reached at the apex 124 of the zone 114. A logarithmic scale determines the distance travelled along vector 1: a maximum score of 1.0 would place the pin at the pinnacle of the Orange Zone 114, while a score equal to or greater than the Rating Difference Threshold [R_{d}] would place the pin temporarily at the Baseline 120.

(2) See vector 2. Once the preliminary height is determined, the distance along vector 2 is determined based on the Importance of the Choice Factor. As the importance score approaches the minimum threshold the pin drifts southwest towards the bottom edge of the Orange Zone 114. As Importance approaches a perfect score of 1.0 the pin drifts northeast towards the right edge of the Orange Zone 114.

(3) See vector 3. Once the distance along vector 2 is determined, the distance from the Baseline 120 is recalibrated to reflect the curvature along the top and bottom of the zone relative to the new horizontal position for an exact placement. A visual indicator is then provided at the exact indicated placement (step 6).

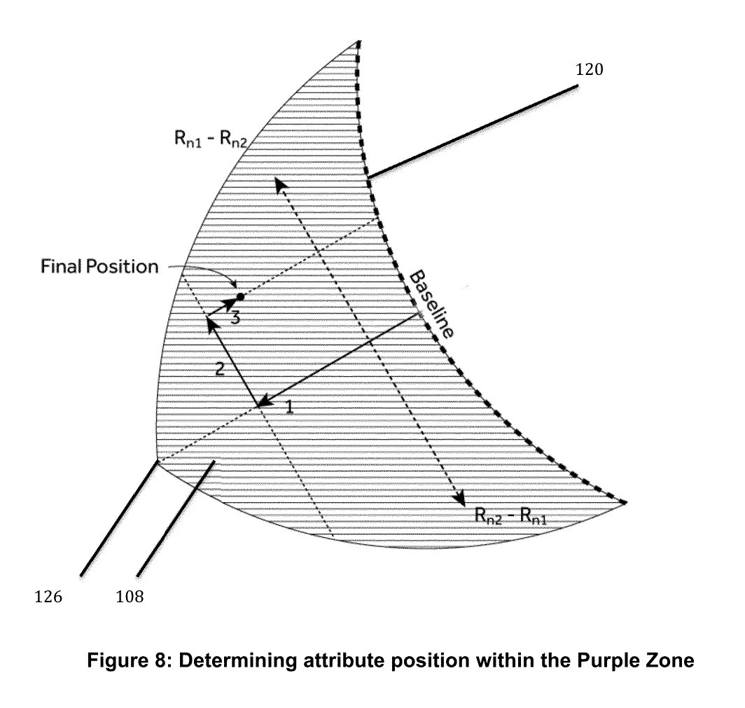

Purple Zone (FIG. 8) The Purple Zone 108 displays Choice Factors that lie within both the Company circle 102 and the Competitor circle 104. See FIG. 8.

(1) See vector 1. Vector 1 is determined based on the Importance score. At the Baseline Importance would be just less than the Importance Threshold [Iₜ], while the minimum Importance is 0.0, this is reached at the apex 126 of the Purple Zone 108. A logarithmic scale determines the distance travelled along vector 1: a minimum score of 0.0 would place the pin at the pinnacle of the Purple Zone 108, while a maximum score of just less than the Importance Threshold [Iₜ], would place the pin temporarily at the Baseline 120.

(2) See vector 2. Once the preliminary distance along vector 1 is determined, the distance along vector 2 is determined. Within the Purple Zone 108 the distance along vector 2 is based on the Rating Difference. If the Company Rating (Rₙ₁) is greater than the Competitor Rating (Rₙ₂) it moves closer to the Blue Zone 132 until it is at the edge of the Blue Zone 132 and vice versa for the competitor rating versus the company rating, moving the pin closer to the Red Zone 134. Once the magnitude of the difference is equal to or greater than the Rating Difference Threshold [R_{d}] it crosses over into the Blue 132 and Red Zones 134 respectively.

(3) See vector 3. Once the distance along vector 2 is determined, the distance along vector 1 is recalibrated to reflect the curvature along the top and bottom of the zone relative to the new horizontal position for an exact placement. A visual indicator is then provided at the exact indicated placement (step 6).

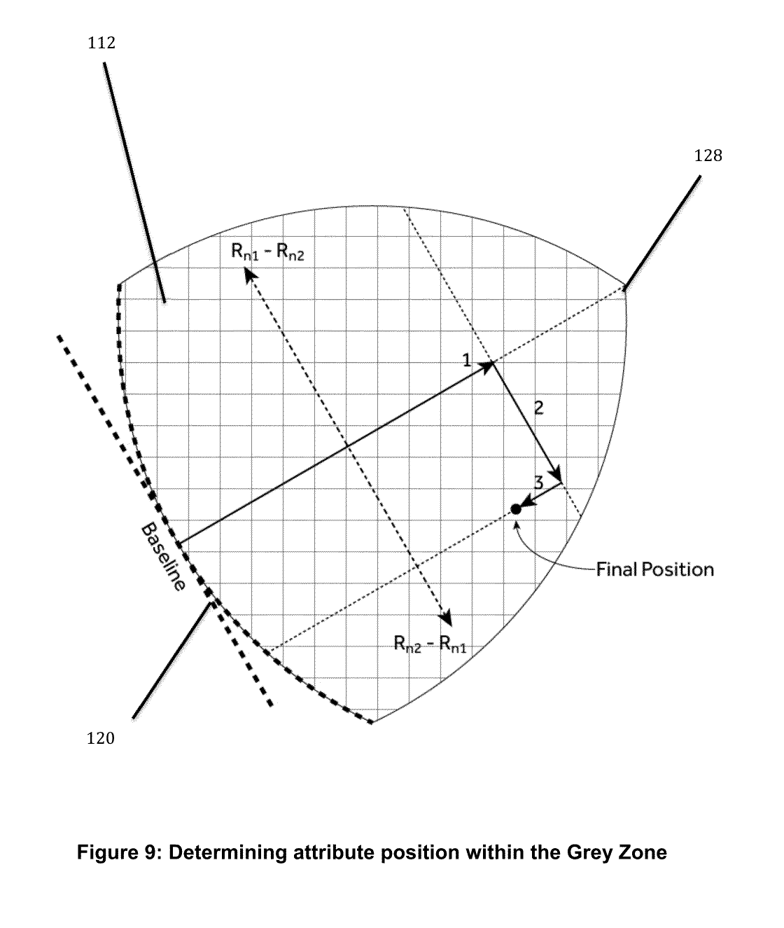

Grey Zone (FIG. 9) The Grey Zone 112 displays Choice Factors that lie within the Company circle 102, the Competitor circle 104, and the Customer circle 106. See FIG. 9.

(1) See vector 1. Vector 1 is determined based on the Importance score. At the Baseline 120 Importance would be equal to or greater than the Importance Threshold [Iₜ], while the maximum Importance is 1.0, this is reached at the upper right pinnacle/apex 128 of the zone. A logarithmic scale determines the distance travelled along vector 1: a maximum score of 1.0 would place the pin at the upper right pinnacle 128 of the Grey Zone, while a minimum score equaling the Importance Threshold [Iₜ] would place the pin temporarily at the Baseline 120.

(2) See vector 2. Once the preliminary distance along vector 1 is determined, the distance along vector 2 is determined. Within the Grey Zone 112 the distance along vector 2 is based on the Rating Difference. If the Company Rating (Rₙ₁) is greater than the Competitor Rating (Rₙ₂) it moves closer to the Green Zone 110 until it is at the edge of the Green Zone 110 and vice versa for the Competitor Rating versus the Company Rating, moving the pin closer to the Orange Zone 114. Once the difference is equal to or greater than the Rating Difference Threshold [R_{d}] it crosses over into the Green 110 and Orange Zones 114 respectively.

(3) See vector 3. Once the distance along vector 2 is determined, the distance along vector 1 is recalibrated to reflect the curvature along the top and bottom of the zone relative to the new horizontal position for an exact placement. A visual indicator is then provided at the exact indicated placement (step 6).

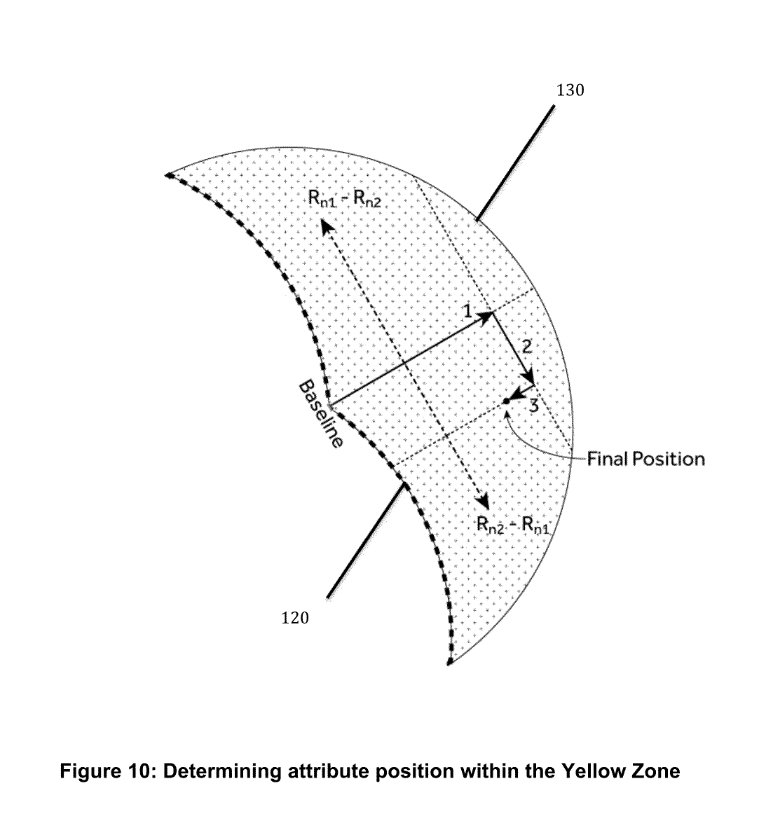

Yellow Zone (FIG. 10) The Yellow Zone 130 displays Choice Factors that lie only within the Customer circle 106. See FIG. 10.

(1) See vector 1. Vector 1 is determined based on the Performance score. At the Baseline Performance would be just less than the Rating Threshold [Rₜ], while the minimum Performance is 0.0, this is reached at the circumference of the yellow circle on the right. A logarithmic scale determines the distance travelled along vector 1: a minimum score of 0.0 would place the pin on the right most edge of the Yellow Zone 130, while a score of up to the Rating Threshold [Rₜ] would place the pin temporarily at the Baseline 120.

(2) See vector 2. Once the preliminary distance along vector 1 is determined, the distance along vector 2 is determined. Within the Yellow Zone 130 the distance along vector 2 is based on the Rating Difference. If the Company Rating (Rₙ₁) is greater than the Competitor Rating (Rₙ₂) it moves closer to south east until it is at the lower right edge of the Yellow Zone 130 and vice versa for the Competitor Rating versus the Company Rating, moving the pin closer to the upper side of the Yellow Zone 130.

(3) See vector 3. Once the distance along vector 2 is determined, the distance along vector 1 is recalibrated to reflect the curvature along the top and bottom of the zone relative to the new horizontal position for an exact placement. A visual indicator is then provided at the exact indicated placement (step 6).

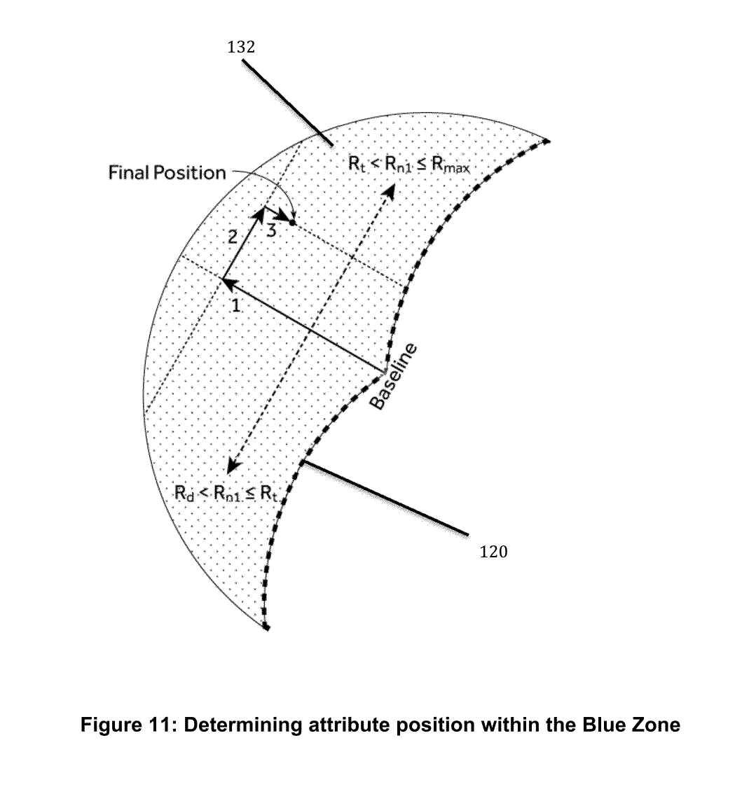

Blue Zone (FIG. 11) The Blue Zone 132 displays Choice Factors that lie only within the Company circle 102. See FIG. 11.

(1) See vector 1. Vector 1 is determined based on the Importance score. At the Baseline Importance would be just less than the Importance Threshold [Iₜ], while the minimum Importance is 0.0, this is reached at the circumference of the blue circle 102 on the left edge. A logarithmic scale determines the distance travelled along vector 1: a minimum score of 0.0 would place the pin on the left most edge of the Blue Zone 132, while a score of up to the Importance Threshold [Iₜ] would place the pin temporarily at the Baseline 120.

(2) See vector 2. Once the preliminary distance along vector 1 is determined, the distance along vector 2 is determined. Within the Blue Zone 132 the distance along vector 2 is based on the Rating Difference. If the Company Rating (Rₙ₁) is greater than the Rating Threshold (Rₜ) it moves closer to the Green Zone 110. If the Company Rating (Rₙ₁) is less than the Rating Threshold (Rd, the pin approaches the Purple Zone 108.

(3) See vector 3. Once the distance along vector 2 is determined, the distance along vector 1 is recalibrated to reflect the curvature along the top and bottom of the zone relative to the new horizontal position for an exact placement. A visual indicator is then provided at the exact indicated placement (step 6).

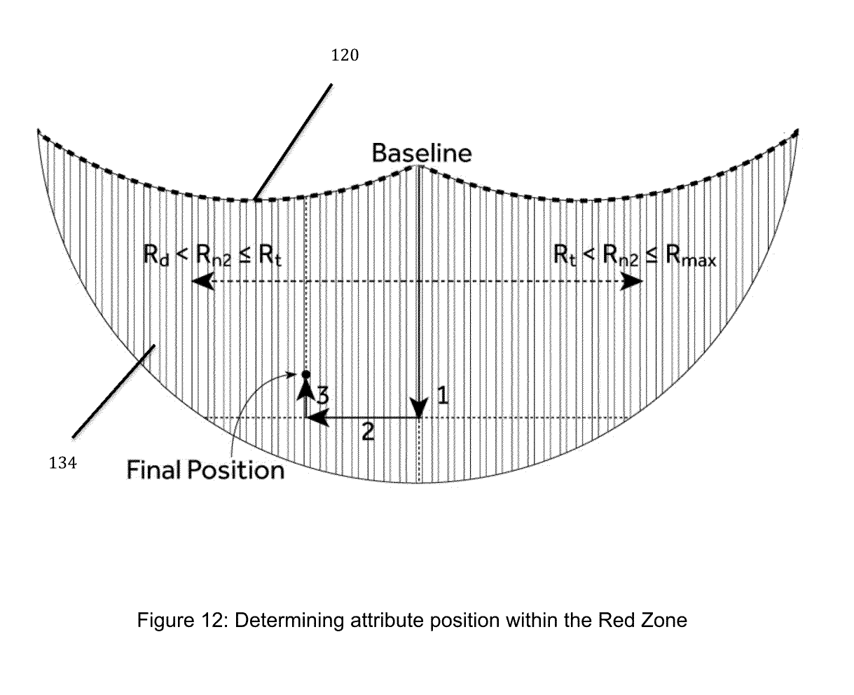

Red Zone (FIG. 12) The Red Zone 134 displays Choice Factors that lie only within the Competitor circle 104. See FIG. 12.

(1) See vector 1. Vector 1 is determined based on the Importance score. At the baseline 120 Importance would be just less than the Importance Threshold N, while the minimum Importance is 0.0, this is reached at the circumference of the red circle 104 on the bottom edge. A logarithmic scale determines the distance travelled along vector 1: a minimum score of 0.0 would place the pin on the left most edge of the Red Zone 134, while a score of up to the Importance Threshold [Iₜ] would place the pin temporarily at the baseline 120.

(2) See vector 2. Once the preliminary distance along vector 1 is determined, the distance along vector 2 is determined. Within the Red Zone 134 the distance along vector 2 is based on the Rating Difference. If the Competitor Rating (Rₙ₂) is greater than the Rating Threshold (Rₜ) it moves closer to the Orange Zone 114. If the Competitor Rating (Rₙ₂) is less than the Rating Threshold (Rₜ), the pin approaches the Purple Zone 108.

(3) See vector 3. Once the distance along vector 2 is determined, the distance along vector 1 is recalibrated to reflect the curvature along the top and bottom of the zone relative to the new horizontal position for an exact placement. A visual indicator is then provided at the exact indicated placement (step 6).

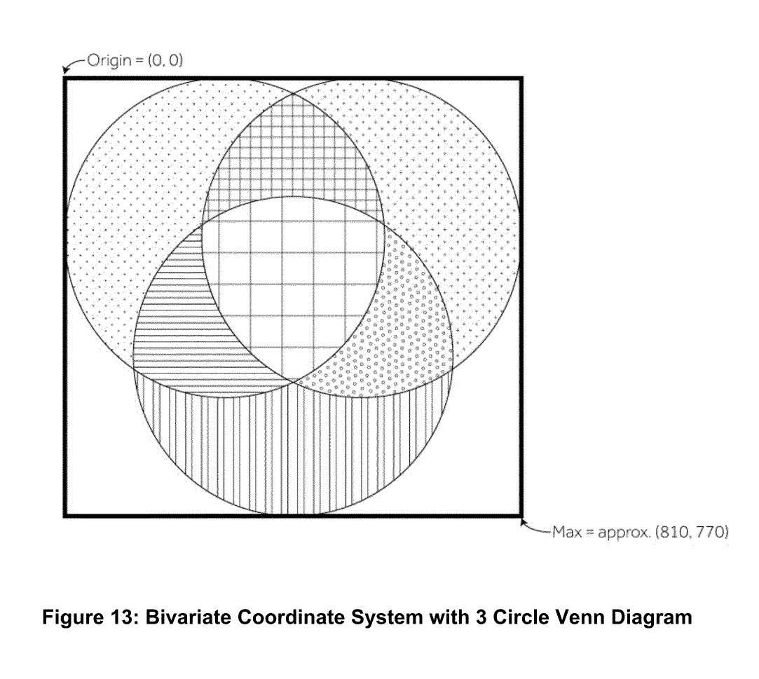

Conversion to Coordinate System (FIG. 13): In order to plot the Choice Factors (attributes) as points on a three circle Venn diagram, the final position of the Choice Factor (attribute) is calculated as two coordinates on a bivariate chart. The origin of the bivariate chart is in the upper left corner of the rectangle surrounding the three (0,0) circle Venn diagram 100. The X coordinate increases as the right hand side of the rectangle surrounding the three circle Venn diagram 100 is approached, while the Y coordinate increases as the bottom side of the rectangle surrounding the three circle Venn diagram 100 is approached. In the shown example, the bivariate coordinate system's coordinates relate to its own unique scale that is not measured in pixels or other objective measure, instead it is calculated in points whereby each circle has a radius of 290 points and the centers of the circles have the following coordinates: Blue=(290, 290), Yellow=(520, 290), Red=(400, 480). The maximum X coordinate then is approximately 810, while the maximum Y coordinate then is approximately 770. See FIG. 13.

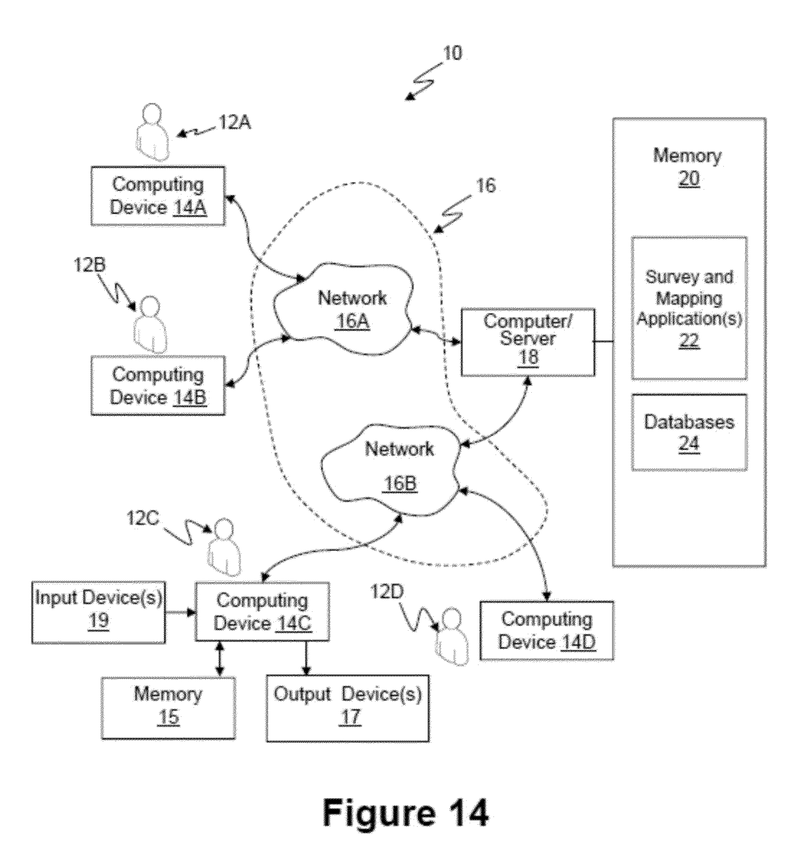

Referring to FIG. 14, an illustrative mapping system 10 of the present disclosure is illustrated. System 10 illustratively includes a plurality of clients or customers 12A-12D using computing devices 14A-14D, respectively, to communicate with a computer/server 18 through an electronic communication network 16. Electronic communication network 16 may be a collection of one or more wired or wireless networks.

Illustratively, computing devices 14 may be general purpose computers or portable computing devices. Although computing device 14 is illustrated as a single computing device, multiple computing devices may be used together, such as over a network or other methods of transferring data. Exemplary computing devices 14 include desktop computers, laptop computers, mobile computing devices such as smartphones or other cellular devices, tablet computers, personal digital assistants (PDAs), e-readers, or other devices capable of the communications discussed herein.

Each computing device 14 has access to a memory 15. Memory 15 is a computer readable medium and may be a single storage device or multiple storage devices, located either locally with computing device 14 or accessible across a network (enterprise or cloud storage). Computer-readable media is any available media that can be accessed by the computing device 14.

Computing device 14 also has access to one or more output devices 17. Exemplary output devices include a display, a speaker, a file, and an auxiliary device. Exemplary auxiliary devices include devices which may be coupled to computing device 14, such as a printer. Files may have various formats. In one embodiment, files are portable document format (PDF) files. In another embodiment, files are formatted for display by an Internet browser, such as Internet Explorer brand browser available from Microsoft Corporation, the Google Chrome brand browser available from Google Inc., the Safari brand browser available from Apple Corporation or the Firefox brand browser available from Mozilla Corporation, and may include one or more of Hypertext Markup Language (“HTML”), or other formatting instructions.

Computing device 14 further has access to one or more input devices 19. Exemplary input devices include a display (such as a touch display), keys (such as a keypad or keyboard), a pointer device (such as a mouse, a roller ball, a stylus), and other suitable devices by which an operator 12 may provide input to computing device 14.

Memory 15 includes operating system software. Exemplary operating system software is a Windows operating system available from Microsoft Corporation. Exemplary operating systems for mobile devices include the Android operating system available from Google Inc. or the iOS operating system available from Apple Corporation. Memory 15 further includes communications software. Exemplary communications software includes e-mail software, Internet browser software, and other types of software which permit computing device 14 to communicate with other computing devices across the network 16. Exemplary networks include a local area network, a cellular network, a public switched network, and other suitable networks. An exemplary public switched network is the Internet.

Each of the customers and/or clients 12A-D are shown with an associated computing device 14A-D, respectively. Computer devices 14A-D each has one or more processors. Of course, a given client 12 may have multiple computing devices 14 through which the client may access a computing device 18 which provides and/or manages surveys and mapping applications 22 as discussed herein. As illustrated, network 16 is shown including a first network 16A and a second network 16B. For example, computing devices 14A and 14B are handheld devices which communicate with computing device 18 through a cellular network 16A while computing devices 14C and 14D are computers which communicate with computing device 18 through a public switched communication network, such as the Internet. In one example, computing devices 14A and 14B also communicate with computing device 18 through the Internet, in that the provider of cellular service provides a connection to the Internet.

Computing device 18 is labelled as Computer/Server because it serves or otherwise makes available to computing devices 14A-14D various surveys and mapping applications 22. In one embodiment, computing device 18 is a web server and the various survey and mapping applications 22 include web sites which are served by computing device 18. Although a single computer/server 18 is shown, multiple computing devices may be implemented to function as computing device 18. Computing device 18 has one or more processors and access to a memory 20. Memory 20 is a computer readable medium and may be a single storage device or multiple storage devices, located either locally with computing device 18 or accessible across a network (enterprise or cloud storage).

The survey and mapping applications 22 are stored in memory 20. In addition to the survey and mapping applications 22, memory 20 stores one or more databases 24 which are used by the survey and mapping applications 22. Computing device 18 is connected to input devices and output devices similar to those discussed above.

A computing device 18 collects data from customer surveys from a plurality of customers 12A-12D using computing devices 14A-14D, respectively. Computing device 18 stores the collected information in databases 24 in memory 20 for retrieval and analysis by the mapping applications 22 as discussed herein. Mapping data for plotting the choice factor locations as discussed herein is sent from computing devised 18 to a company's computing device 14A-D for display.

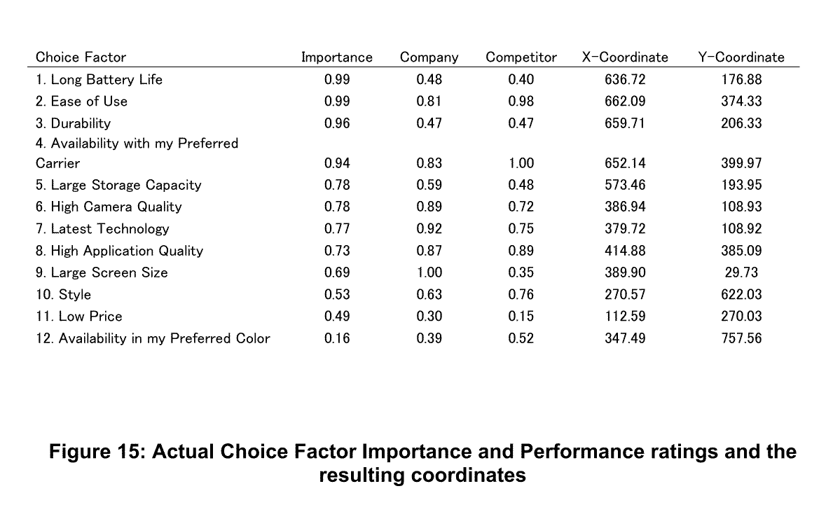

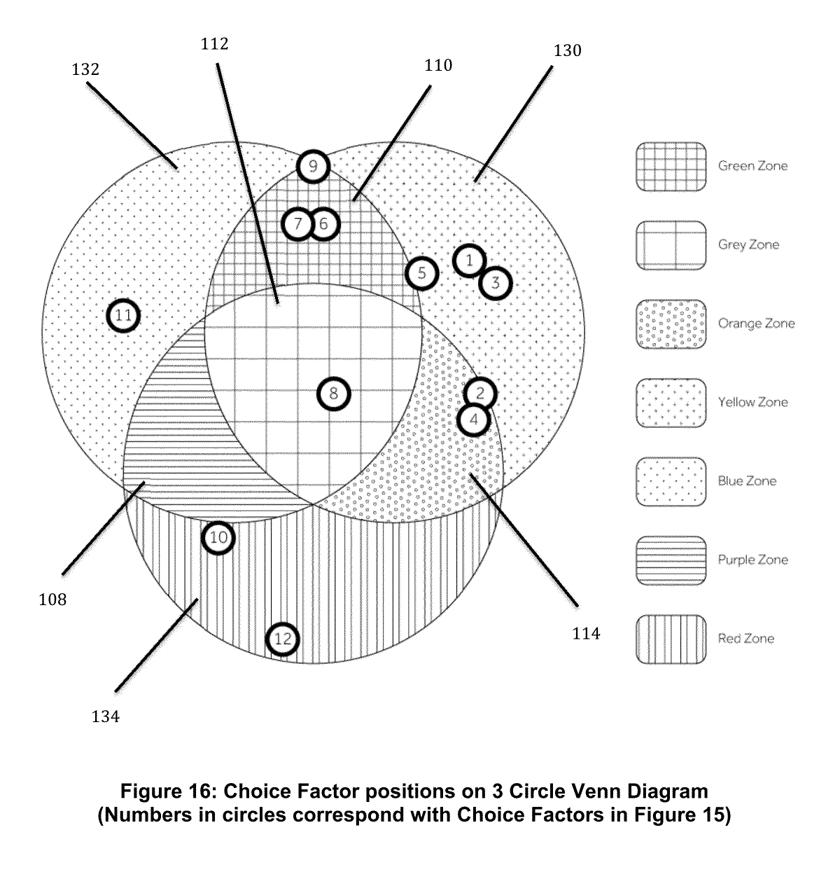

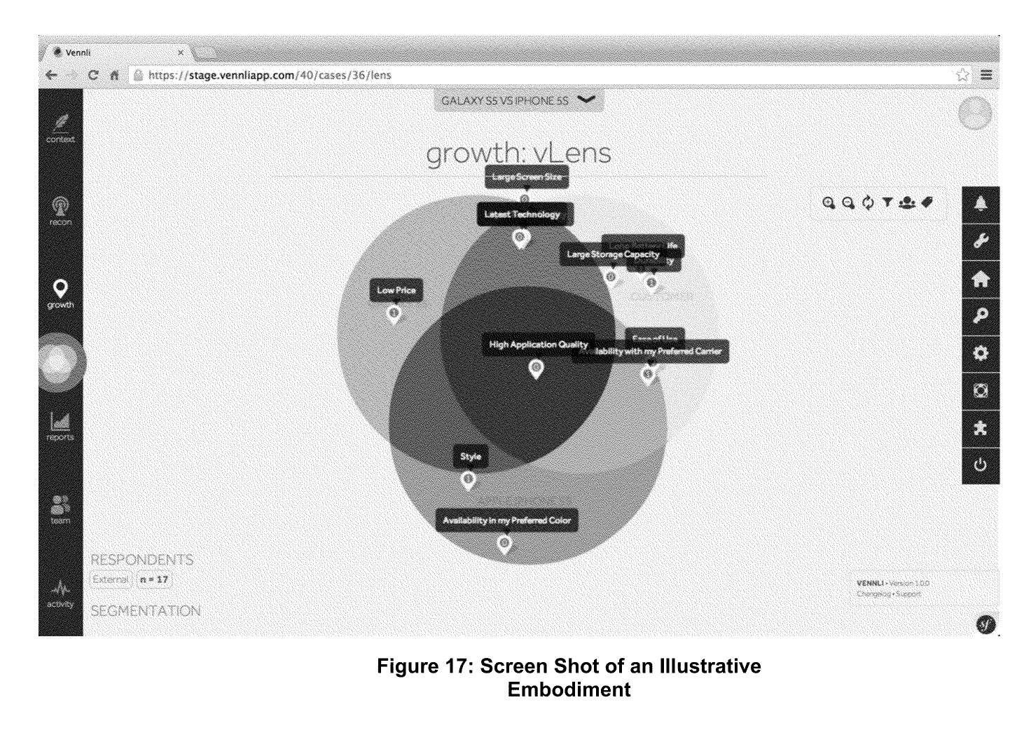

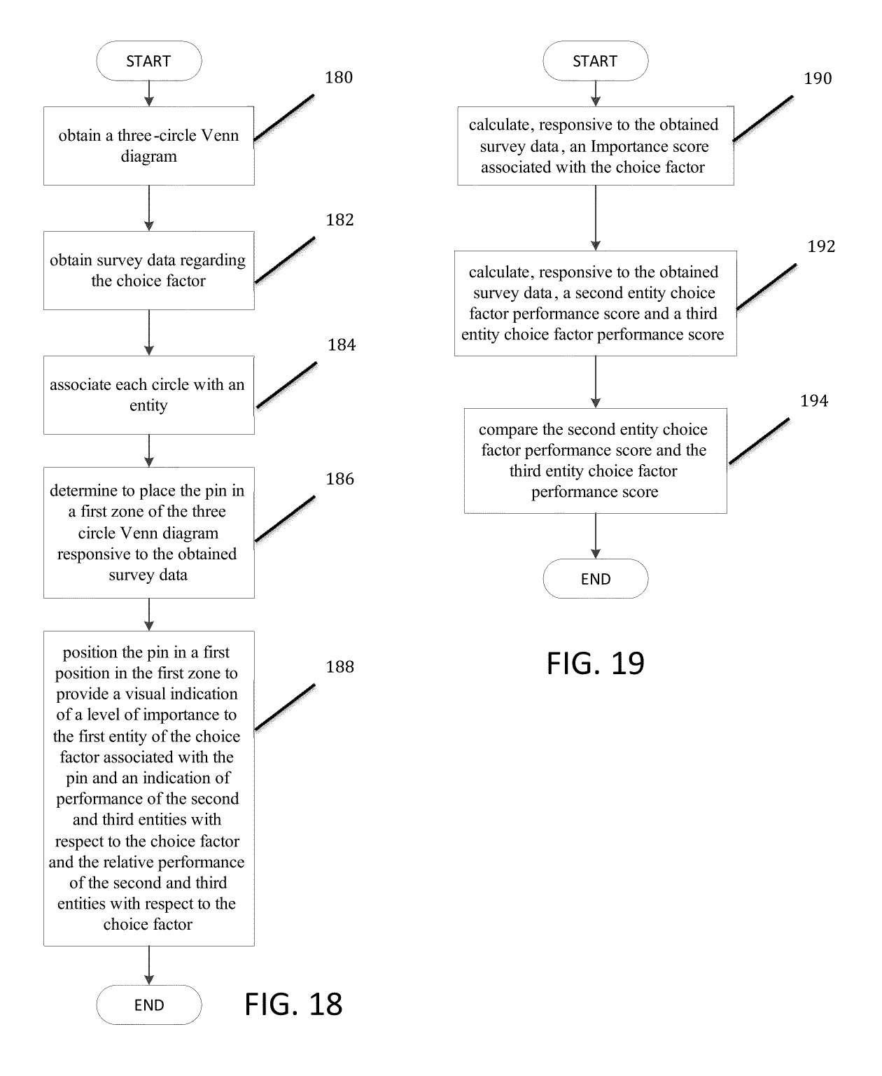

An illustrative example of the mapping system and method of the present disclosure is shown in FIGS. 15-17. FIGS. 15-17 illustrate a case study involving the cell phones Samsung S5 and Apple iPhone 5S. In this example, the user is illustratively a team from Samsung wanting to understand how to improve market share for the Samsung S5 cellphone by winning market share from the Apple iPhone 5S. The team at Samsung has decided to test 12 Choice Factors (product attributes). The Choice Factors (product attributes) are as follows:

1. Long Battery Life

2. Ease of Use

3. Durability

4. Availability with my Preferred Carrier

5. Large Storage Capacity

6. High Camera Quality

7. Latest Technology

8. High Application Quality

9. Large Screen Size

10. Style

11. Low Price

12. Availability in my Preferred Color

The team obtains a three-circle Venn diagram (block 180). Survey data is then obtained for the identified choice factor(s) (block 182) from, for example, survey manager devices 18. Each circle of the Venn diagram is associated with an entity (block 184). Here, the entities are Samsung S5, Apple iPhone 5S, and customers. The received data is used to place each choice factor pin in a zone (block 186). The specific position within a zone for each choice factor pin is chosen to provide a visual indication of a level of importance to the customer and to provide an indication of the performance of the two products with respect to the choice factor and the relative performance of the two products (block 188).

The determined zone and specific placement with the zone is determined by using the survey data. The survey data is used to calculate an importance score associated with each choice factor (block 190). The survey data is further used to calculate a performance score for each of the products (block 192). The performance score for both products are compared (block 194). The importance score and compared performance scores are then used to determine the zone and the placement within the zone.

In this example, based on the data generated from the Vennli survey platform, the three circle Venn diagram 100 reveals that Large Screen Size, Latest Technology, and Durability are competitive advantages for the Samsung S5 over the Apple iPhone 5S. These three Choice Factors (attributes) appear in the Green Zone 110. Similarly, the Orange Zone 114 is populated with Ease of Use, and Availability with my Preferred Carrier implying that these are competitive advantages of the Apple iPhone 5S over the Samsung S5. Long Battery Life, Durability, and Large Storage Capacity appear in the Yellow Zone 130 (unmet needs) revealing that the customer perceives both products as falling short on customer expectations. See FIGS. 15-17 for detailed illustrations.

While this disclosure has been described as having exemplary designs and embodiments, the present invention may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains. Therefore, although the invention has been described in detail with reference to certain illustrated embodiments, variations and modifications exist within the spirit and scope of the invention as described and defined in the following claims.

1. A method including:
generating, by a mapping device, a visual depiction of survey data related to a choice factor weighed by one or more customers or potential customers when deciding what brands, products or services to purchase, the survey data being represented by a pin for the choice factor on a three circle Venn diagram including a plurality overlapping and non-overlapping zones, wherein placement of the pin on the Venn diagram is determined by:
obtaining survey data regarding the choice factor from one or more survey manager devices;
associating each circle of the three circle Venn diagram with respective first, second, and third entities to which the choice factor is related;
determining to place the pin in a first zone of the three circle Venn diagram responsive to the obtained survey data; and
positioning the pin in a first position in the first zone to provide a visual indication of a level of importance to the first entity of the choice factor associated with the pin and an indication of performance of the second and third entities with respect to the choice factor and the relative performance of the second and third entities with respect to the choice factor, wherein the first position is determined by:
calculating, responsive to the obtained survey data, an Importance score associated with the choice factor;
calculating, responsive to the obtained survey data, a second entity choice factor performance score and a third entity choice factor performance score; and
comparing the second entity choice factor performance score and the third entity choice factor performance score.

2. The method of claim 1, wherein first, second, and third circles of the three circle Venn diagram represent attributes of a brand, product, or service desired by a customer, attributes offered by a company's brand, product, or service; and attributes offered by a competitor's brand, product or service, respectively.

3. The method of claim 2, wherein overlapping zones of the three circle Venn diagram represent an equivalence between offerings of the company's brand, product, or service and the competitor's brand, product, or service or the equivalence between what is offered by the company's brand, product, or service and what is desired by the customers.

4. The method of claim 1, wherein a location of the pin in the determined zone reveals a degree of importance and a degree of perceived ownership of the associated choice factor by a brand, product, or service from the perspective of the customer.

5. The method of claim 1, further comprising calculating an Importance score [Iₙ], a Company Performance score [Rₙ₁] and a Competitor Performance score [Rₙ₂] for the choice factor before determining in which zone of the three circle Venn diagram to place the pin associated the choice factor.

6. The method of claim 5, wherein the zone within the Venn diagram for the choice factor is determined by comparing the Importance score [Iₙ], the Company Performance score [Rₙ₁], and the Competitor Performance score [Rₙ₂] to an Importance Threshold [Iₜ], a Rating Threshold [R₁], and a Rating Difference Threshold [R_{d}], respectively.

7. The method of claim 6, wherein a first zone is defined within the first circle and outside the second and third circles; the first position being defined within the first zone when Rₙ₁<Rₜ and Rₙ₂<Rₜ; a second zone is defined within the second circle and outside of the first and third circles, the first position being defined within the second zone when Iₙ<Iₜ and (Rₙ₁−Rₙ₂)>Rₜ; and a third zone is defined within the third circle and outside of the first and second circle; the first position being defined within the third zone when Iₙ<Iₜ and (Rₙ₂−Rₙ₁)>Rₜ.

8. The method of claim 7, wherein a fourth zone is defined within the first and second circles and outside of the third circle; the first position being within the fourth zone when Iₙ≧Iₜ and (Rₙ₁−Rₙ₂)>Rₜ; a fifth zone is defined within the first and third circles and outside of the second circle; the first position being defined within the fifth zone when Iₙ≧Iₜ and (Rₙ₂−Rₙ₁)>Rₜ; and a sixth zone is defined within the second and third circles and outside of the first circle; the first position being defined within the sixth zone when Iₙ<Iₜ and |(Rₙ₂−Rₙ₁)|<Rₜ.

9. The method of claim 8, wherein a seventh zone is defined within the first, second, and third circles; the first position being within the seventh zone when Iₙ≧Iₜ and |(Rₙ₂−Rₙ₁)|<Rₜ.

10. The method of claim 9, wherein the first position being located within the first zone is indicative of a customer desire unmet by a company's offering and unmet by a competitor's offering.

11. The method of claim 10, wherein the first position being located within the second zone is indicative of the company's offering's ownership of an attribute that is not desired.

12. The method of claim 11, wherein the first position being located within the third zone is indicative of the competitor's offering's ownership of an attribute that is not desired.

13. The method of claim 12, wherein the first position being located within the fourth zone is indicative of the company's offering's ownership of an attribute that is desired.

14. The method of claim 13, wherein the first position being located within the fifth zone is indicative of the competitor's offering's ownership of an attribute that is desired.

15. The method of claim 14, wherein the first position being located within the sixth zone is indicative of an attribute common to the company' offering and to the competitor's offering that is not desired.

16. The method of claim 15, wherein the first position being located within the seventh zone is indicative of an attribute common to the company' offering and to the competitor's offering that is desired.

17. The method of claim 5, wherein positioning each pin at the first position in the determined zone includes:
moving the pin along a first vector transverse to a baseline of the determined zone using a logarithmic scale applied to a rating difference of the choice factor to determine a distance travelled along the first vector;
moving the pin along a second vector transverse to the first vector using the Importance score for the choice factor to determine the distance moved along the second vector; and
moving the pin vertically along a third vector to recalibrate a location of the pin to reflect a curvature along a bottom of the zone.

18. The method of claim 1, wherein positioning the pin in the determined zone provides a visual indication of the importance of an associated choice factor includes calculating a position of the pin corresponding to each choice factor as two coordinates on a bivariate chart.

19. The method of claim 1, further including placement of a second pin on the diagram indicative of a second choice factor.
